(19) United States
(12) Patent Application Publication
(10) Pub. No.: US 2010/0026027 A1
(43) Pub. Date: Feb. 4, 2010

(54) Vehicle Cargo Bed Extender-Tailgate Assembly

(76) Inventor: Frank Fang Gao, (US)

Correspondence Address: Frank F. Gao, 21 Hidden Valley Drive, Newark, DE, 19711, US

(21) Appl. No.: 12/534,107

(22) Filed: Aug. 1, 2009

Related U.S. Application Data
(60) Provisional application No. 61/137,785, filed on Aug. 4, 2008.

(51) Int. Cl. B62D 33/08

(52) U.S. Cl. 296/26.11

(57) ABSTRACT

A truck cargo bed extender-tailgate assembly has three extension boards that are hinged with the tailgate. When extra cargo volume is desired, the assembly is lowered to a horizontal position. The left and right extension sideboards fold up to upright positions and pinned respectively with the left sidewall and the right sidewall of the truck bed. The extension backboard folds up to an upright position and is pinned with the upright left extension sideboard and the upright right extension sideboard. With three extension boards at upright positions, the cargo bed is extended by an length equal to the height of the tailgate. The extension backboard can be lowered from its upright position backward to a horizontal position, further extending the cargo bed floor. When the extended cargo bed is no longer needed, three extension boards can be easily folded down to their stowed positions to resume the original vehicle length.

### CROSS-REFERENCE TO RELATED APPLICATIONS

This application claims priority from U.S. Provisional Application Ser. No. filed on Aug. 4, 2008, and the contents of which are incorporated herein by reference in its entirety.

### STATEMENT REGARDING FEDERALLY SPONSORED RESEARCH OR DEVELOPMENT

Not applicable.

### TECHNICAL FILED OF THE INVENTION

The technical field of the present invention relates to enhancement of pickup truck functions, in particular, for those pickup trucks with extended driver's cabs. More specifically, the present invention relates to a truck cargo bed extender that includes three extension boards, which are assembled with the tailgate and are foldable for easy operation and effective cargo bed extension.

### BACKGROUND OF THE INVENTION

Historically, a major task of a pickup truck has been to transport items or loads with heavy weights or large volumes, including but not being limited to, heavy equipment and tools, materials for construction and home-improvements, large pieces of furniture, plants and materials for landscaping, etc. To fulfill this task, a truck cargo bed is designed as a major part of the pickup truck. A cargo bed is in general an open-top rectangular box that consists of a bed floor and four sidewalls. The four sidewalls are: the front wall which is actually the back-wall of the driver's cab, the left sidewall, the right sidewall, and the back wall called “tailgate.” The volumetric space surrounded by the four sidewalls above the bed floor determines the cargo capacity of the pickup truck. The tailgate, which is hinged with the rear edge of the bed floor, is usually the only wall that can be opened and lowered to the level of the bed floor to allow easy loading and unloading.

In the past two decades or so, pickup trucks have been designed and made more family-friendly by adding a bench-seat behind the driver-passenger seats. Children or other family members can sit on the bench-seat while parents are on the driver-passenger seats. Thus, in addition to transporting heavy or volumetric loads, a family can use the pickup truck for family activities, such as shopping and traveling. To enhance the family-friendly nature, some more recent models are equipped with full-sized rear seats with ample leg rooms.

Pickup trucks for business have also been redesigned with full-sized rear seats so that 4 to 6 members of a crew can sit in the cab. Such pickups are therefore termed as “crew-cap” or “super-crew” models. In addition, many small business owners and contractors have mounted toolboxes to their pickups to store and carry necessary and valuable tools and devices. Those toolboxes are usually mounted permanently between the two sidewalls of the cargo bed, and immediately behind the driver's cab. Such toolboxes, though serving properly the intended purposes of protecting valuable tools and devices, reduce significantly the remaining cargo space.

Adding a bench seat or full-sized rear seats requires a significant expansion of the driver's cab toward the back. Such backward expansion reduces significantly the volumetric capacity of the cargo bed, thus hindering the original function of cargo transportation. To solve this problem, some manufacturers have increased the length of the truck bed (such as the so-called “long-bed” models), which inevitably leads to an increase in the total length of the vehicle. The long-bed models are likely to create some difficulties in some situations, such as driving and parking in a crowded parking lot, and parallel parking. A long-bed vehicle also requires an extended garage, which may not be readily available in a residential house. In addition, longer truck beds are associated with extra steel, aluminum, rubber and other materials needed for frame, bed floor and sidewalls.

Efforts have been made in the past to extend cargo capacity without increasing the overall length of the cargo bed. The U.S. Pat. No. 2,872,239 (issued to Bowness and Scott, Feb. 3, 1959) and U.S. Pat. No. 4,472,639 (issued to Bianchi, Sep. 18, 1984) revealed a folding design that would allow a significant cargo expansion. The shortcoming of this design was that the back sideboard could not be leveled backward and thus limited the flexibility and the practicability of the extended structure. The U.S. Pat. Nos. 4,531,773 (issued to Smith, Jul. 30, 1985) and 7,264,292 (issued to Summers, Sep. 4, 2007) revealed similar extending structures with folding panels. Those two patents did not improve the previous design. In addition, they both involved in some sliding mechanisms, which would complicate manufacturing process and add operational instability of the extending structure. The U.S. Pat. No. 4,778,213 (issued to Palmer, Oct. 18, 1988) revealed another design with an extended or auxiliary tailgate that could be folded backward to extend the bed floor. However, the fixed or rigid position of the two auxiliary side panels of Palmer's design would hinder proper function of the tailgate when the original tailgate is lowered. In addition, Palmer's extender itself would take certain cargo space at stowed position. The U.S. Pat. No. 5,700,047 (issued to Leitner and Weisel, Dec. 23, 1997) revealed a fence-type extender. Later, the U.S. Pat. Nos. 6,120,076 (issued to Adsit and Wong, Sep. 19, 2000), 7,007,995 (issued to Scarberry and Wright, Mar. 7, 2006), and 7,121,604 (issued to Reed, Oct. 17, 2006) revealed other fence-type extenders, which has been used by a few truck manufacturers. The shortcomings of those fence-type extenders are that (1) their own storage needs significant on-vehicle space, and (2) the fence structure would fail to contain loose particle-type cargo items when the size of those items are smaller than the openings between adjacent fence bars.

Apparently, there is need in the art for a cargo bed extension that can effectively address the aforementioned dilemma associated with extra-cab pickup trucks. Although there have been a few extenders in the art to address this need, the present invention, with its special design and function features, provides a simple, more effective and practical method to add to the art.

### SUMMARY OF THE INVENTION AND ADVANTAGES

The present invention provides a simple and practical system that will effectively increase the cargo volume when necessary but will not require an increase in bed length when such an extension is not needed, thus not interfering with the normal operation of the cargo bed and the vehicle.

One embodiment of the present invention can be characterized by an extender-tailgate assembly (or simply referred to as “tailgate assembly”) being manufactured and installed on brand-new pickup trucks. The tailgate assembly consists of two extension sideboards, one extension backboard, and one tailgate baseboard. The left extension sideboard, the right extension sideboard and the extension backboard are connected with fixed hinges to the left edge, the right edge and the top edge of the tailgate baseboard, respectively. The two sideboards are folded onto the backboard, and together they are assembled onto the tailgate baseboard. At a normal condition, the tailgate assembly can be locked in its upright position, or lowered to a level position, functioning just as a common tailgate. When a larger-than-normal cargo volume becomes desirable, the tailgate assembly is first lowered to its level position. The two extension sideboards are lifted, leftward and rightward respectively, to their upright positions and pin-locked with the left sidewall and right sidewall of the cargo bed, respectively. The extension backboard is then lifted backward to its upright position and combined with the left extension sideboard and the right extension sideboard by the connectors at the upper left corner and upper right corner, respectively. The two extension sideboards and the extension backboard, at their upright positions, form an additional cargo volume to the original capacity. When necessary, the extension backboard is lowered from its upright position backward to a level position and held with a second set of supporting cables, further extending the cargo bed floor.

When the larger-than-normal cargo volume is no longer needed after unloading, the extension backboard and two sideboards are folded back, step by step in an opposite order, to their stowed positions on the tailgate baseboard. The whole tailgate assembly is then lifted to resume its upright position.

An alternate of the above embodiment is to modify the fixed hinges to detachable hinge-pairs, so that the left extension sideboard, the right extension sideboard and the extension backboard become detachable from the tailgate baseboard. With this alternate embodiment, when extra cargo volume is not needed, the three extension boards are stored separately from the tailgate, either behind the rear seats in the driver's cab or even separate from the vehicle such as in a parking garage. When extra cargo capacity is desired, the three extension boards are easily hinged to the tailgate baseboard by the detachable hinge-pairs, and thereafter are operated as described above for the extender-tailgate assembly. After the extra-cargo tasks are finished, the extension boards are detached easily from the tailgate and stored separately.

Another embodiment can be characterized by a cargo bed extender package that can be installed on a tailgate of a used pickup truck. The extender package consists of two extension sideboards, one extension backboard, and one base-frame. The two sideboards and the backboard are hinged on the base-frame, which is preferably made of a light but strong metallic material. The said base-frame can be mounted onto the inner side of an existing tailgate, and the extender package can then function as afore-described for the tailgate assembly. For this embodiment, it becomes necessary to design and make individual extender packages to fit individual models of used pickup trucks. Installation of the extender package onto an existing tailgate may need professional tools and skills, and minor alternations of the tailgate itself to accommodate the extension sideboards and backboard. The work can be done conveniently at professional shops, such as dealers' repair-shops and auto body-shops. Once the installation is finished, the combination of the extender package and the existing tailgate provides users the same conveniences and advantages as those of a manufacturer-made tailgate assembly on a brand new pickup truck.

An alternate embodiment of the above extender package can be characterized by changing all the fixed hinges between the three extension boards and the base frame to detachable hinge-pairs, so that after the base frame is installed onto the inner side of the tailgate, the three extension boards are easily hinged to, and detached from, the base frame and thus the tailgate.

Apparently, the present invention enhances the family-friendly and business-efficient nature of all pickup trucks that have extra cabs by overcoming major drawbacks and disadvantages associated with the longer-than-normal drivers' cabs or the longer-than-normal cargo beds. The embodiments of the present invention provide pickup truck owners convenience and flexibility.

With the embodiments using fixed hinges, the extension sideboards and backboard are just built-in components of the tailgate, and the total length of the vehicle is not affected. The extender-tailgate assembly or the extender package does not alter the normal operation and function of the pickup truck and the tailgate. When an extra cargo capacity is needed, the extension system can be easily and conveniently deployed to meet the owners' needs. After the extra-cargo job is done, the extension sideboards and backboard can be easily and quickly resumed to their stowed positions.

With the alternate embodiments using detachable hinge-pairs, the extension sideboards and backboard can be easily hinged to the tailgate baseboard or the extender package base frame when an extra cargo volume is needed. After the extra-cargo job is done, the extension sideboards and backboard can be easily detached and separated from the tailgate baseboard or the extender package base frame, and the tailgate itself resumes to its original condition. After detachment, the extension sideboards and backboard can be stored in the vehicle (such as in a space behind the rear seats in the driver's cab), or separately from the vehicle (such as in owner's parking garage).

The present invention is likely to reduce, if not eliminate, the need of manufacturing long-bed pickup trucks, resulting in cost savings on materials for extended base-rails, bed-floor, and bed sidewalls. Such savings are likely more than enough to compensate costs for making extension boards and related parts. Many residential garages, which cannot accommodate long-bed pickup trucks, are ample to accept extra-cab pickups with the extension embodiments of the present invention. Thus, the tailgate assembly of this invention is likely a potential selling feature to attract homeowners. In addition, the convenience and flexibility of the cargo extension embodiments of the present invention shall attract more small business owners and contractors, who have frequent needs for expanded cargo capacities.

The embodiments of the present invention can be readily applied to pickup trucks that do not have extra cabs. This is especially true for small business owners and contractors, who often install a permanent toolbox, which is immediately behind the drivers' cab and occupies a significant bed cargo space. Also, the embodiments of the present invention can be used on other types of vehicles with a tailgate structure, such as some models of mini-vans, jeeps and sport-utility-vehicles (SUVs), providing those vehicles cargo expansion flexibility.

### BRIEF DESCRIPTION OF THE DRAWINGS

The present invention can become easily and clearly envisioned by the following drawings.

FIG. 1 is a diagram of a typical pickup truck, with an extended cab, in its normal position. FIG. 1A is an exploded view of the rear part of the truck cargo bed, with the extender-tailgate assembly (or simply referred to as tailgate assembly) of the present invention at its normal upright position.

FIG. 2 is a diagram of the rear part of the cargo bed, with its tailgate assembly at a lowered (i.e., flat) position.

FIG. 3 is a diagram of the rear part of the cargo bed, with two extension sideboards at their upright (i.e., vertical) positions, while the extension backboard stays at an inward flat position on top of the tailgate baseboard.

FIG. 4 is a diagram of the rear part of the cargo bed, with two extension sideboards and the extension backboard at their upright (i.e., vertical) positions, thus creating an enclosed extension for the original cargo volume.

FIG. 5 is a diagram of the rear part of the cargo bed, with two extension sideboards at their upright positions and the extension backboard at an outward flat position, which creates an extension for the tailgate baseboard.

FIG. 6 shows two leveling panels, whose functions will be explained later.

FIG. 7 is a diagram of an alternate embodiment of the tailgate assembly, depicting detachable hinge-pairs for connections between the left extension sideboard and the tailgate baseboard, between the right extension sideboard and the tailgate baseboard, and between the extension backboard and the tailgate baseboard. FIG. 7 shows only partial views of the connections, with one hinge-pair for each connection.

FIG. 8 is a diagram of a cargo bed extender base-frame, on which an extension backboard and two extension sideboards are hinged to form a cargo bed extender package. The extender package can be then mounted to the inner surface of an existing tailgate.

FIG. 9, and associated FIGS. 9A, 9B and 9C, are diagrams showing how a mounting bracket with a 45-degree pivoting slot works for an existing tailgate after an extender package is mounted to its inner surface.

FIG. 10 is a diagram of a base-frame of an alternate embodiment of the cargo bed extender package in which detachable hinge-pairs replace the fixed hinges so that the left extension sideboard, the right extension sideboard and the extension backboard become detachable from the tailgate.

### DETAILED DESCRIPTION OF THE PREFERRED EMBODIMENTS

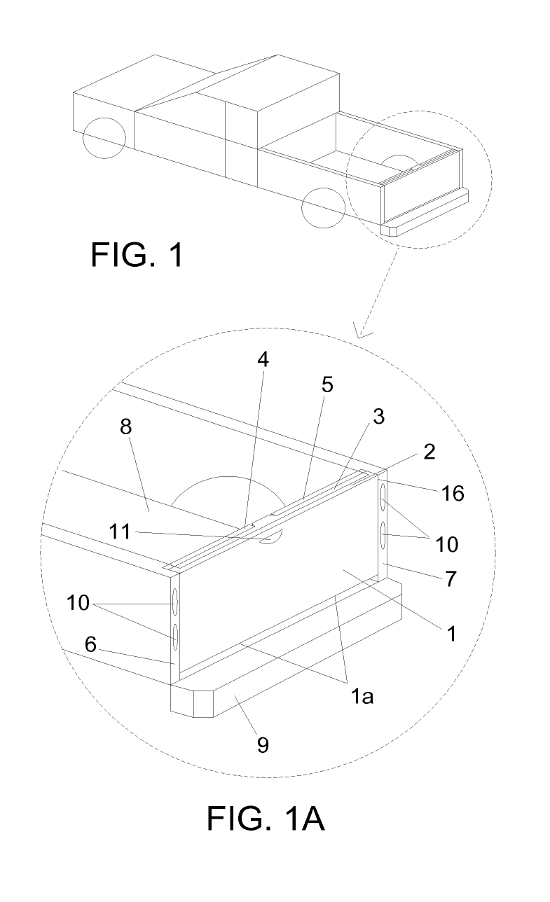

The description herein provides details of how the present invention works. The description is presented progressively along with FIGS. 1 to 10, in which the same numerals are used to identify the same structural components of the invention embodiments.

In FIG. 1, a pickup truck is depicted perspectively, not to exact scale, with an extended cab, a cargo bed which is shortened due to the existence of the extended cab. FIG. 1A is an exploded diagram of the rear part of the pickup truck cargo bed. Depicted therein are a tailgate assembly 1, a tailgate baseboard 2, an extension backboard 3, a left extension sideboard 4, a right extension sideboard 5, a left sidewall 6, a right sidewall 7, a main truck bed floor 8, a rear bumper 9, several rear lights 10, and a tailgate assembly latch release handle 11.

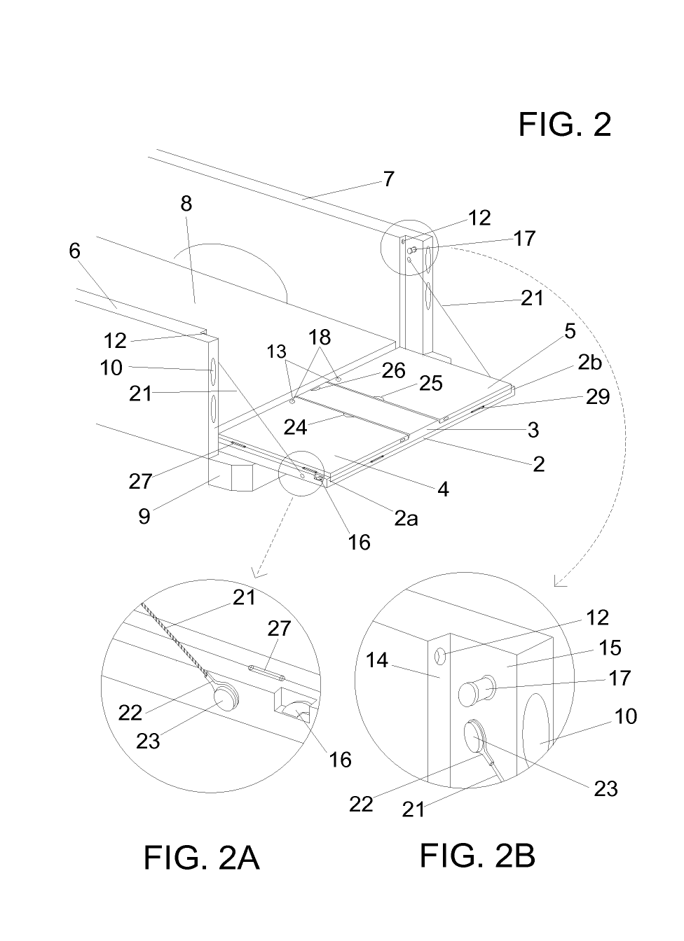

In FIG. 2, the said tailgate assembly 1 is lowered to its flat position. Depicted in FIG. 2, in addition to those depicted in FIG. 1, are extension sideboard snap pinholes 12, extension sideboard snap pins 13 (spring-supported pins, their locations labeled but not seen in FIG. 2), tailgate forward jamb 14, tailgate outward jamb 15, tailgate latch 16, tailgate latching pin 17, tailgate latching pin housings 18, tailgate supporting cable 21, circular cable-hook 22, cable end retainer 23, left extension sideboard release handle 24, right extension sideboard release handle 25, extension backboard release handle 26, two left extension sideboard hinges 27, and two extension backboard hinges 29. Also depicted in FIG. 2 are a left-edge block 2a and a right-edge block 2b of the tailgate baseboard 2. The said extension backboard 3 sits in the space between the said block 2a and the said block 2b. The tailgate assembly is attached to the left and right outward jambs 15 at their bottom portions with two pivoting pins, one pin on each jamb, as normally done for a regular tailgate.

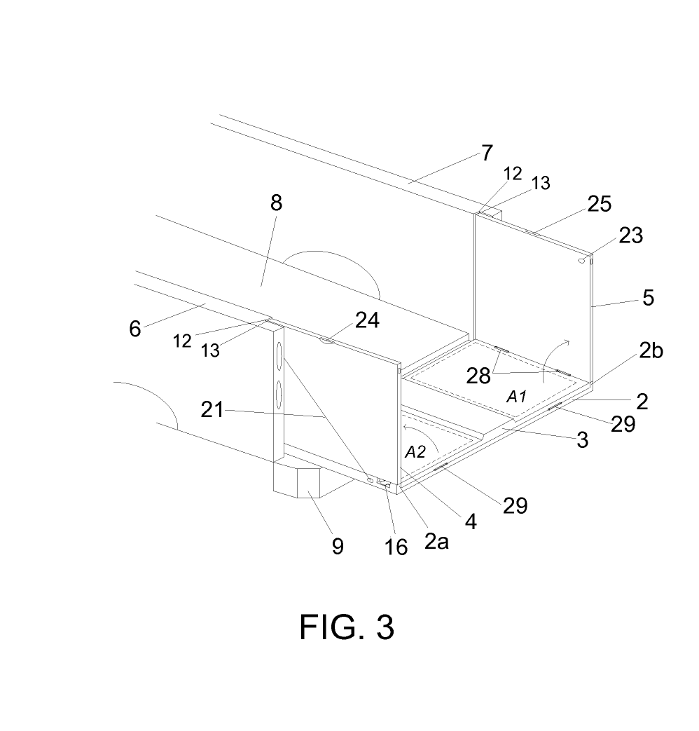

FIG. 3 shows that two extension sideboards 4 and 5 are lifted to their vertical positions, extending the cargo bed sidewalls 6 and 7, respectively, by a length equal to the height of the sidewall. Depicted in FIG. 3, in addition to those in FIG. 2, are two right extension sideboard hinges 28.

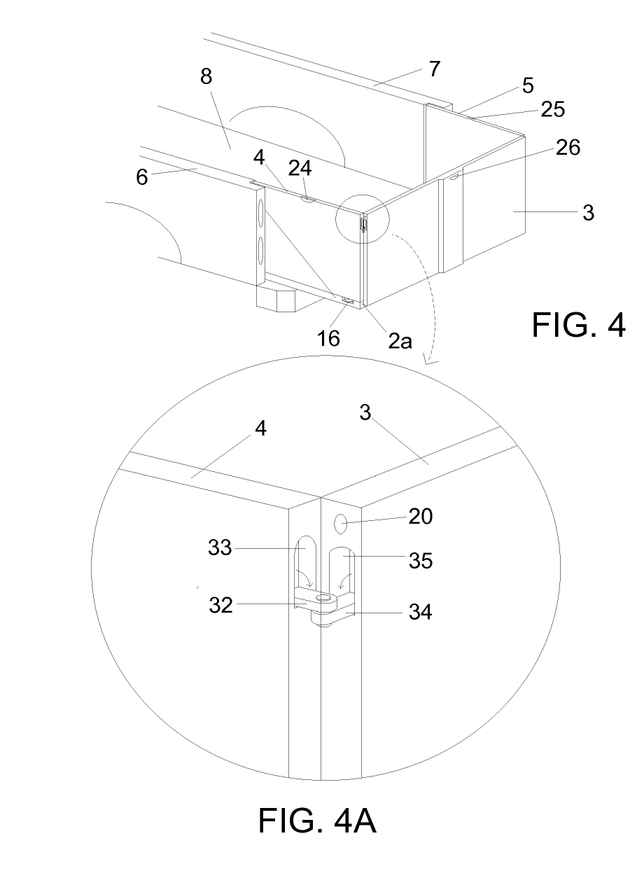

In FIG. 4, depicted are, in addition to those in the previous figures, extension backboard snap pinhole 20, extension sideboard male connector 32, male connector housing 33, extension backboard female connector 34, and female connector housing 35. The said male connector 32 and the said female connector 34 can be folded in and out from the said connector housings 33 and 35, respectively. As shown in FIG. 4, the extension backboard 3 is lifted to its vertical position. The vertical position of the backboard 3 is steadily held by the male connector 32 on the left extension sideboard 4 (and the right extension sideboard 5, but not shown in FIG. 4) and the female connector 34 on the extension backboard 3, being connected at the upper corners of the sideboard 4 (and the sideboard 5) and the backboard 3, as shown in FIG. 4A. The rod of the male connector 32 and the hole of the female connector 34 are so designed that the combination of the two provides a strong structural connection of the sideboard 4 (and the sideboard 5) and the backboard 3. The embodiment of FIG. 4 extends effectively the truck cargo bed by a length equal to the height of the tailgate (also the height of the truck bed sidewall).

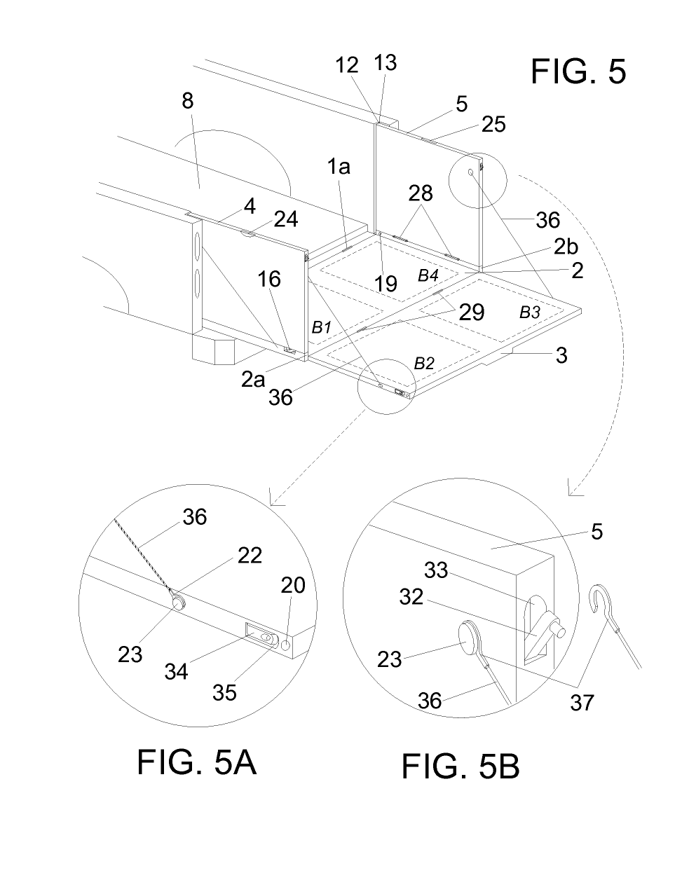

In FIG. 5, depicted are, in addition to those in the previous figures, an extension backboard snap pin 19 located at the bottom inner side of the right-edge block 2b (another snap pin located at the bottom inner side of the left-edge block 2a, but not seen in FIG. 5), the extension backboard supporting cable 36, and an open circular cable-hook 37. The spring-supported snap pin 19 can be snapped into the snap pinhole 20 (shown in FIG. 5A) when the extension backboard 3 is in its stowed position as shown in FIG. 3. In FIG. 5, the extension backboard 3 is lowered further backward (i.e., outward) to its flat position, thus extending the cargo bed floor 8 by an additional length equal to the height of the tailgate (i.e., the height of the bed sidewall). The open cable-hook 37 allows the extension backboard supporting cable 36 to be detached from the cable end container 23 on the right extension sideboard 5, as shown in FIG. 5B. The same open cable-hook is provided for the cable that connects the left extension sideboard 4, but not seen in FIG. 5.

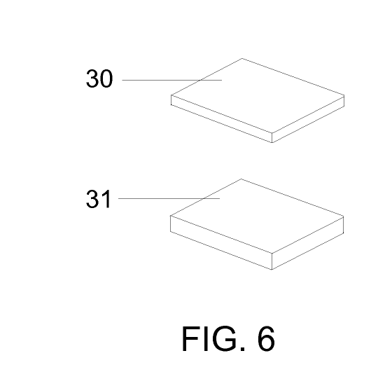

In FIG. 6, depicted are a thin leveling panel 30, and a thick leveling panel 31. For the present embodiment, two thin leveling panels (designated as A1, A2) and three thick leveling panels (designated as B1, B2, B3) are designed. The dimension of A1 and A2 is identical, and is so designed that they can be placed on top of the stowed extension backboard (at locations indicated by A1 and A2 in FIG. 3) to create a level (i.e., even) surface between the main bed floor 8 and the extended floor, whenever such a level surface is needed. When overlapping together, the thickness of A1 and A2 together is equal to the thickness of a thick leveling panel (B1, B2, or B3). The dimension of B1, B2 and B3 is identical, and is so designed that they can be placed on top of the extended portion of the bed floor, at the positions marked by B1, B2, and B3, respectively, in FIG. 5. The combination of A1 and A2 can be placed at the position marked by B4 in FIG. 5. The placement of B1, B2, B3 and A1+A2 can create a level surface between the main bed floor 8 and the extended floor, whenever such a level surface is needed. The leveling panels are designed as accessories according to conventional concept and are not included as a part of the present invention.

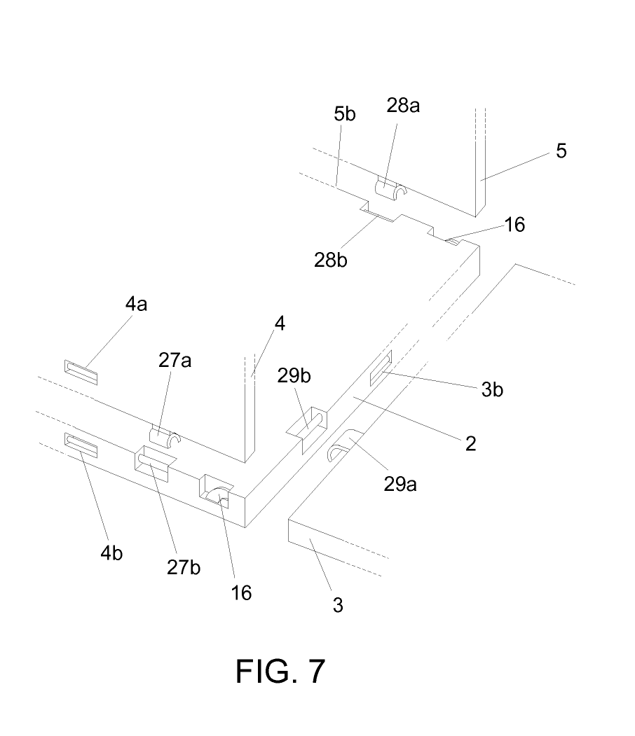

In FIG. 7, depicted are, in addition to those in the previous figures, a detachable hinge-pair 27a-27b for hinging the left extension sideboard 4 to the tailgate baseboard 2 (there should be at least one more hinge-pair for the left extension sideboard 4, but not shown in FIG. 7), a detachable hinge-pair 28a-28b for hinging the right extension sideboard 5 to the tailgate baseboard 2 (there should be at least one more hinge-pair for the right extension sideboard 5, but not shown in FIG. 7), and a detachable hinge-pair 29a-29b for hinging the extension backboard 3 to the tailgate baseboard 2 (there should be at least one more hinge-pair for the extension backboard 3, but not shown in FIG. 7). With the said detachable hinge-pairs 27a-27b, 28a-28b and 29a-29b, the left extension sideboard 4, the right extension sideboard 5, and the extension backboard 3 are easily hinged to, and detached from, the tailgate baseboard 2. The detachability of the three extension boards is the major feature of this alternate embodiment of the present invention. Under this alternate embodiment, the left-edge block 2a and the right-edge block 2b of the tailgate baseboard become unnecessary.

Also shown in FIG. 7 is a fastening rod-pair 4a-4b for the left extension sideboard 4, upon which a common detachable and adjustable fastening belt can be applied to secure the connection between the left extension board 4 and the tailgate baseboard 2 (the fastening belt is not shown in FIG. 7). A fastening rod-pair 3a-3b and a fastening rod-pair 5a-5b are also included in this alternate embodiment to secure the extension backboard 3 and the right extension sideboard 5, respectively (but only fastening rod 3b is seen, and location of fastening rod 5b is labeled but not seen, in the perspective view of FIG. 7). For shake-reducing purpose, a liner of robber, PVC or other vibration-absorbing materials can be added onto the inner surfaces of the detachable hinge partners 27a, 28a and 29a, or the outer surfaces of the detachable hinge partners 27b, 28b and 29b. The fastening rod-pairs, fastening belt and vibration-absorbing liner are designed according to conventional concepts and are not included as a part of the present invention. In addition, with this embodiment, the detachable extension backboard can be made of two hinge-connected boards; each has a height of the extension backboard and a length of one half of the extension backboard. Then, the extension backboard can be folded in the middle to reduce its overall dimension for easy storage.

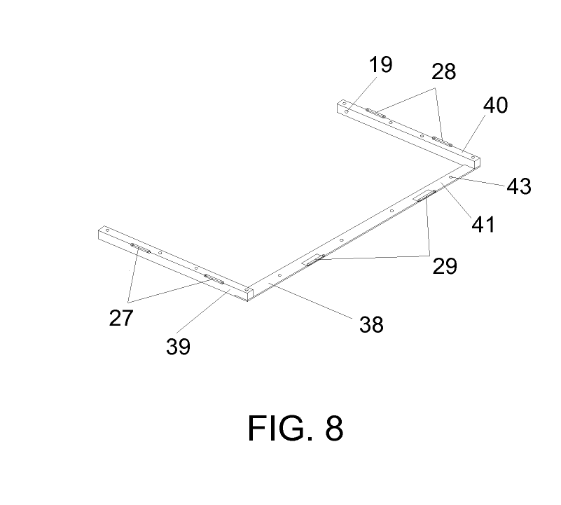

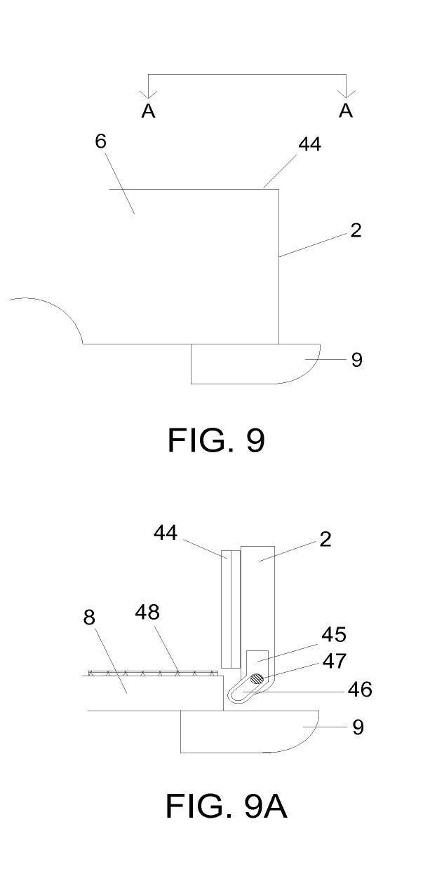

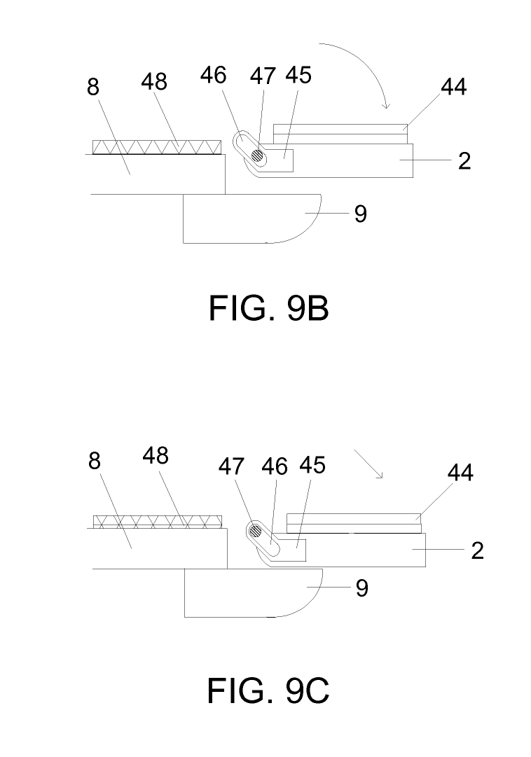

In FIG. 8, depicted is a base-frame 38 of a cargo bed extender package. The said base-frame 38 consists of a left-side block 39, a right-side block 40, and a top ruler plate 41. An extension backboard 3 (not shown in FIG. 8 but shown in FIG. 3) is attached to the top ruler plate 41 by two hinges 29. Two spring-supported pins 19 (showing only one on the right-side block 40 in FIG. 8) keep the extension backboard 3 in a stowed position. A left extension sideboard 4 (not shown in FIG. 8 but shown in FIG. 3) is attached to the left-side block 39 by two hinges 27, and a right extension sideboard 5 (not shown in FIG. 8 but shown in FIG. 3) is attached to the right-side block 40 by two hinges 28. The base-frame 38, the extension backboard 3 (not shown in FIG. 8), the left extension sideboard 4 and the right extension sideboard 5 (not shown in FIG. 8) together construct a cargo bed extender package 44 (not shown in FIG. 8, but in FIG. 9). The base-frame 38 can be bolted tightly to the inner surface of the tailgate through bolt holes 43 (a total of 12 holes shown in FIG. 8). The dimension of the base-frame 38 is so designed that the extender package 44 can be accommodated between the left sidewall 6 and the right sidewall 7 when the tailgate is in the upright stowed position. The mounting of the extender package to the tailgate inner surface constructs a tailgate extension assembly, which is similar to what is depicted in FIG. 1 through FIG. 6, and functions similarly.

In FIG. 9, depicted are a cargo bed extender package 44 bolted to the inner surface of a tailgate 2 (both extender package 44 and tailgate 2 are behind the left sidewall 6 and are not seen). The cross-section A-A, as specified in FIG. 9, is shown in FIG. 9A, in which depicted are a pivot bracket 45, with a 45-degree pivoting slot 46, welded on each end-side of the tailgate 2, a pivot pin 47 installed at the bottom of outward jamb 15 of each sidewall (not shown in FIG. 9A, but in FIG. 2), and a rubber liner 48 laid on the cargo bed floor 8. When the tailgate 2 is in its upright position, the gravity keeps it at its normal position where the pivot pin 47 is at the right end of the pivoting slot 46, as shown in FIG. 9A. When the tailgate 2 is lowered outward to its flat position, the surface of the extender package 44 is initially higher than the surface of the bed liner 48, as shown in FIG. 9B. However, the tailgate 2 sits quickly, by gravity, to its stable position where the pivot pin 47 is at the left end of the pivoting slot 46, and the surface of the extender package 44 is lowered to the same level as the surface of the bed liner 48, as shown in FIG. 9C. In this case, the tailgate supporting cable 21 (not shown in FIG. 9A, FIG. 9B and FIG. 9C, but in FIG. 2) is extended by a length equal to the length of the pivoting slot 46 minus the diameter of the pivoting pin 47.

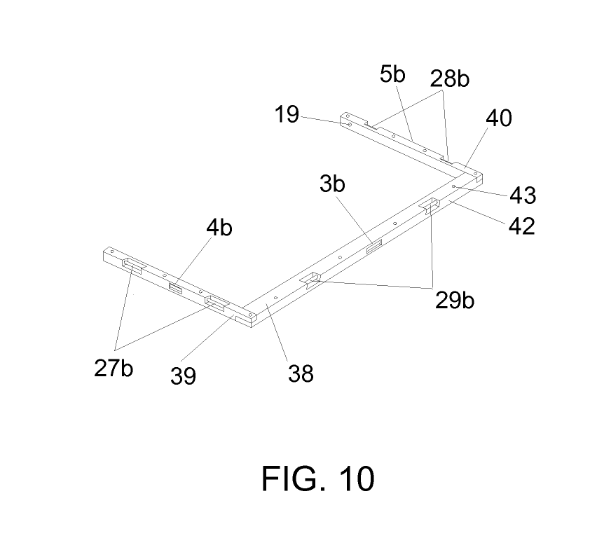

FIG. 10 shows an alternate embodiment of the base-frame in FIG. 8, and its cargo bed extender package. In FIG. 10, depicted are, in addition to those in FIG. 8, a top block 42 of the extender base-frame 38, the left extension sideboard hinge-pair partner 27b (another partner 27a is not shown in FIG. 10, but in FIG. 7), the right extension sideboard hinge-pair partner 28b (another partner 28a is not shown in FIG. 10, but in FIG. 7), and the extension backboard hinge-pair partner 29b (another partner 29a is not shown in FIG. 10, but in FIG. 7). With the alternate embodiment shown in FIG. 10, the extension backboard 3 (in FIG. 7), the left extension sideboard 4 (in FIG. 7), and the right extension sideboard 5 (in FIG. 7) become detachable from the base-frame 38. In addition, installation and operation of the extender package of this alternate embodiment will not require any position change of the tailgate. Therefore, the pivot bracket 45 and the pivot pin 47 in FIG. 9 become unnecessary.

What is claimed is:

1. A pickup truck cargo bed extender-tailgate assembly comprising: a left extension sideboard; a right extension sideboard; an extension backboard; and a tailgate baseboard onto which the extension backboard, the left extension sideboard and the right extension sideboard are hinged and assembled.

2. The tailgate baseboard in claim 1 further comprising a left-end block with a round-top snap pin at its bottom inner side; a right end block with a round-top snap pin at its bottom inner side; and the space between the two said end blocks accommodates the said extension backboard in claim 1.

3. The left extension sideboard of claim 1 further comprising a round-top snap pin at its upper front corner on the edge side; a release handle at its central top end to control the said snap pin; a male connector which is stored in a housing at the upper rear corner on the edge side and can be bent out; a cable-end retainer at the upper rear corner on the inner side; two hinges at its bottom edge to be used to couple with the left-end block of the tailgate baseboard in claim 2.

4. The right extension sideboard of claim 1 further comprising a round-top snap pin at its upper front corner on the edge side; a release handle at its central top end to control the said snap pin; a male connector which is stored in a housing at the upper rear corner on the edge side and can be bent out; a cable-end retainer at the upper rear corner on the inner side; two hinges at its bottom edge to be used to couple with the right-end block of the tailgate baseboard in claim 2.

5. The extension backboard of claim 1 further comprising two round pinholes, each at its upper left corner on the edge side and at its upper right corner on the edge side, respectively; a release handle at its central top end which, when being pulled, pushes outward two rods, each housed in one of the said pinholes; two female connectors which are stored in two housings, each at its upper left corner on the edge side and at its upper right corner on the edge side, respectively, and can be bent out; a left cable-end retainer and a right cable-end retainer, each at a position below the said left connector housing and the said right connector housing, respectively; two hinges at its bottom edge to be used to couple with the top end of the tailgate baseboard in claim 1.

6. The extender-tailgate assembly in claim 1 further comprising: a left supporting cable which connects (1) the cable-end retainer of the left extension sideboard in claim 3 with an open circular hook and (2) the left cable-end retainer of the extension backboard in claim 5 with a closed circular hook; a right supporting cable which connects (1) the cable-end retainer of the right extension sideboard in claim 4 with an open circular hook and (2) the right cable-end retainer of the extension backboard in claim 5 with a closed circular hook; and the said open circular hooks have an opening which is slightly greater than the diameters of the said cable-end retainers in claims 3 and 4.

7. The left extension sideboard in claim 3 and the right extension sideboard in claim 4 each further comprising a matching pinhole as an accessory, which is installed on the tailgate forward jamb of a truck left and right sidewall, respectively, to accommodate the snap pin of each extension sideboard.

8. The extender-tailgate assembly in claim 1 comprising alternately: detachable hinge-pairs that allow the said left extension sideboard in claim 3, the said right extension sideboard in claim 4, and the said extension backboard in claim 5 to be easily hinged to, and detached from, the said tailgate baseboard in claim 1.

9. A pickup truck cargo bed extender package comprising: a left extension sideboard; a right extension sideboard; an extension backboard; an extension base-frame onto which the said extension backboard, the said left extension sideboard and the said right extension sideboard are hinged and assembled.

10. The left extension sideboard, the right extension sideboard and the extension backboard in claim 9 further comprising all featured parts of the left extension sideboard in claim 3, the right extension sideboard in claim 4 and the extension backboard in claim 5, respectively, and other featured parts in claim 6 and claim 7, and assuming the same functions.

11. The extension base-frame in claim 9 further comprising: a left-end block which has a round-top snap pin at its bottom inner side, and two hinges to connect the said left extension sideboard; a right-end block which has a round-top snap pin at its bottom inner side, and two fixed hinges to connect the said right extension sideboard; a top-end block which connects the said left-end block and the said right-end block at their top ends, and has two hinges to connect the said extension backboard; the said left-end block, the said right-end block, and the said top-end block each has 4 bolt holes to allow each of them to be bolted and mounted to the left edge, right edge and the top edge, respectively, of the inner surface of an existing tailgate.

12. The bed extender package in claim 9 further comprising two pivot brackets as accessories, each can be welded or bolted onto each side-jamb at the lower end of an existing tailgate; each said bracket with a 45-degree pivoting slot which allows the said tailgate to slide into a normal upright position, and when lowered to its flat position, to slide into a lower level.

13. The extender package in claim 9 comprising alternately: detachable hinge-pairs to replace the said fixed hinges in claims 10 and 11, thus allowing the said extension backboard, the said left extension sideboard, and the said right extension sideboard in claim 10 to be easily hinged to, and detached from, the said extension base-frame in claim 11; no pivot brackets in claim 12.
